(19) United States
(12) Patent Application Publication
(10) Pub. No.: US 2026/0350086 A1
(43) Pub. Date: Nov. 5, 2026

(54) DYNAMIC GENERATION OF SEQUENCED LOCATION-BASED MEDIA USING ARTIFICIAL INTELLIGENCE FOR PRESENTATION ON A COMPUTING DEVICE

(71) Applicant: ChariTrek, Inc., Deer Park, WA (US)

(72) Inventors: Grant Bishop, Deer Park, WA (US); Dustin Greer, Meridian, ID (US)

(21) Appl. No.: 19/198,874

(22) Filed: May 5, 2025

Related U.S. Application Data
(63) Continuation-in-part of application No. 19/199,058, filed on May 5, 2025, now abandoned.
Application No. 19/199,058 is a continuation of application No. 17/403,718, filed on Aug. 16, 2021, now Pat. No. 12,313,423.
Application No. 17/403,718 is a continuation of application No. 14/613,239, filed on Feb. 3, 2015, now Pat. No. 11,112,265.
(60) Provisional application No. 61/935,003, filed on Feb. 3, 2014.

(51) Int. Cl. G06F 16/487; G06F 16/435

(52) U.S. Cl. CPC G06F 16/487; G06F 16/435

(57) ABSTRACT

Dynamic localized media experiences are generated using artificial intelligence (AI) models. A computing device receives user input to initiate a localized media experience at a geographic zone. The device determines user features that define user preferences or user interaction patterns. A first set of AI models dynamically generates localized media experiences by mapping user features to feature vectors within a latent space and uses the feature vectors to generate the localized media experiences. The localized media experiences are each mapped to a beacon identifier associated with the geographic zone. The localized media experiences are accessible based on the proximity between the computing device and corresponding beacons. The technology enables personalized, location-based/localized media experiences across different geographic areas.

### TECHNICAL FIELD

The present disclosure relates to dynamic localized media systems and methods and in particular implementations to computer-operated systems and methods that provide a set of dynamic media to individuals with respect to geographic locations.

### BACKGROUND

Currently, individuals are able to navigate computer landscapes such as those landscapes that are presented virtually on an interface such as a screen within an automobile or a mobile device such as a mobile computerized telephone, for example. These techniques have become closer and closer to reality as the presentation of the data becomes more and more realistic. These systems and methods typically provide the user with the ability to navigate between points in a predefined route, providing turn-by-turn directions to reach specific destinations. While effective for basic wayfinding, traditional navigation systems typically present a linear path from point A to point B, without considering real-time factors or user preferences that may influence route selection and/or data presentation along a route. As a result, users may find themselves constrained by the limitations of these pre-programmed routes and presented data when encountering changing circumstances (e.g., changing user preferences, changing user movements).

### BRIEF DESCRIPTION OF THE DRAWINGS

Implementations of the disclosure are described below with reference to the following accompanying drawings.

FIG. 1 is a depiction of a user in relation to points according to an implementation of the disclosure.

FIG. 2 is a system (e.g., a localized media generation platform) with an operator according to an implementation of the disclosure.

FIG. 3 is an interface of a system (e.g., a localized media generation platform) that may be used by an operator according to an implementation of the disclosure.

FIG. 4 is a user in a setting with a system according to an implementation of the disclosure.

FIG. 5 is another presentation of an interface and an operator in relation to points according to an implementation of the disclosure.

FIG. 6 is an overview of a mobile vehicle in relation to points according to an implementation of the disclosure.

FIG. 7 is a computer operating system according to an implementation of the disclosure.

FIG. 8 is an optional set of paths according to an implementation of the disclosure.

FIG. 9 is a bidirectional experience/tour (a set/series of dynamic localized media) according to an implementation of the disclosure.

FIG. 10 is another alternative experience/tour (a set/series of dynamic localized media) according to an implementation of the disclosure.

FIG. 11 is a method for providing a computer aided experience/tour according to an implementation of the disclosure.

FIG. 12 is a process for collecting and storing locations in a database using the localized media generation platform according to an implementation of the disclosure.

FIG. 13 is a process for collecting data used to generate dynamic localized media experiences according to an implementation of the disclosure.

FIG. 14 is an example of a database of collective interests according to an implementation of the disclosure.

FIG. 15 is an example of a database of individual interests according to an implementation of the disclosure.

FIG. 16 is a process for retrieving data within a collection of interests according to an implementation of the disclosure.

FIG. 17 is a process for determining new media whereby using a trigger for a localized media experience according to an implementation of the disclosure.

FIG. 18 illustrates an example environment of dynamically generating localized media experiences using a localized media generation platform while a user moves through different geographic zones, in accordance with some implementations of the technology.

FIG. 19 illustrates an example environment of dynamically generating localized media experience variations using a localized media generation platform before a user moves through different geographic zones, in accordance with some implementations of the technology.

FIG. 20 illustrates an example environment of dynamically generating command sets associated with localized media experience variations using a localized media generation platform before a user moves through different geographic zones, in accordance with some implementations of the technology.

FIG. 21 illustrates an example environment of linking a digital collectible to a user based on the user interacting with a particular localized media experience using a localized media generation platform, in accordance with some implementations of the technology.

FIG. 22 is a flow diagram illustrating a process of dynamically generating localized media experiences using the localized media generation platform, in accordance with some implementations of the technology.

FIG. 23 illustrates a layered architecture of an AI system that can implement the machine learning (ML) models of a localized media generation platform, in accordance with some implementations of the present technology.

FIG. 24 is a block diagram showing some of the components typically incorporated in at least some of the computer systems and other devices on which a localized media generation platform operates in accordance with some implementations of the present technology.

FIG. 25 is a system diagram illustrating an example of a computing environment in which a localized media generation platform operates in some implementations of the present technology.

The drawings have not necessarily been drawn to scale. For example, some components and/or operations are separated into different blocks or combined into a single block for the purposes of discussion of some of the implementations of the disclosed system. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Media experiences refer to digital content presented to inform, entertain, or otherwise engage users through various forms of media such as audio, video, text, and/or images. These experiences can range from informational displays to interactive games, virtual reality experiences, etc. and can be specific to particular contexts (e.g., a food, historical, or interactive context) and/or locations (e.g., a zoo, museum, or park). Conventional media experiences are typically presented in a predefined, linear sequence. Users typically progress through a series (e.g., a sequence) of predetermined content and interactions. For instance, a digital experience (e.g., a tour) of a historical site can guide users through a series of fixed points of interest and present information and interactive elements in a specific order.

However, conventional approaches to generating and presenting media experiences, while informative, often lack flexibility and personalization. Users are generally confined to the originally generated experience (or sequence of experiences). In conventional systems, when users deviate from the prescribed order of a route, they often encounter information that is out of context or lacks the background provided by previous points in the sequence. For example, in a historical walking tour, if a visitor skips ahead to a later stop, the visitor misses the historical context from earlier locations that potentially causes confusion or a fragmented narrative. Conventional systems have attempted to address this challenge by including introductory information at every single location to ensure that the user is provided with context. However, another challenge emerges with this approach since, as users move between locations, they may repeatedly encounter the same introductory or contextual information, even if the user has already accessed it at a previous point. The repetition not only wastes computational resources used in generating and/or presenting the redundant information but can also lead to user disengagement. For instance, in a museum setting, being presented the same general introduction at multiple exhibits can become tedious for visitors and unnecessarily consume device battery life and/or network bandwidth.

Furthermore, the one-size-fits-all nature of a single data stream fails to account for the diverse preferences and backgrounds of users. For example, some visitors desire in-depth historical details, while others prefer brief overviews or focus on visual elements. A fixed narrative cannot adapt to varying levels of interest or prior knowledge. In addition to the lack of diversity in data streams, conventional systems often struggle to incorporate real-time or near-real-time external factors, such as temporary exhibit closures, animal feeding times at a zoo, special events, and so forth. Similarly, varying real-time or near-real-time factors such as weather conditions, time of day, or seasonal changes may affect the accessibility of certain information, which a static data stream cannot adapt to.

As such, the inventors have developed systems and methods for dynamically generating localized media experiences (hereinafter the “localized media generation platform”). The localized media generation platform can receive user input to define multiple geographic zones, each representing a physical area or marker. The localized media generation platform accesses and links different sets of localized media experiences to each zone. For one or more zones, the localized media generation platform defines criteria for selecting which experience to provide to a user based on their location. The localized media experiences can be associated (e.g., linked, mapped) to unique beacons (e.g., iBeacon, QR code, GPS location, photo, marker, manual entry, distinct sound/beacons, NFC beacons, web site creation, and so forth) associated with each zone. The localized media experiences can be accessed based on a proximity or activation of a computing device with the beacon. The localized media generation platform can generate localized media experiences based on, for example, user preferences, movement patterns, interaction history, and so forth.

Further, in some implementations, the localized media generation platform can dynamically generate and deliver personalized and localized (e.g., location-based) media experiences as users move through physical spaces. As the user moves through a physical space, one or more AI model(s) can dynamically generate a personalized path and/or personalized localized media experiences along a path (e.g., personalized beacon locations, personalized content at each beacon). The experiences can vary based on the user's current location and movement, previously visited locations, user-based criteria/preferences and history, external factors (e.g., a zoo's closing hours), proximity to other users (e.g., via near-field communication (NFC) connectivity), available Internet connectivity, user choices, user engagement, and so forth. Throughout the experience (or sequence of experiences), the AI model(s) can use user interactions, feedback, and/or engagement to modify content relevance in real-time, update the user's profile, and inform future content generation (i.e., the experience/tour AI agent). The localized media experiences can include tours, games, educational experiences, interactive storytelling, and so forth.

In some implementations, the dynamically generated experiences are selected from pre-generated experience variations or generated from pre-generated prompts for each predefined geographic zone (e.g., which can be provided by a user). For example, if a user is traveling to Washington D.C., the user is enabled to provide their parameters for their tour (i.e. June 10-14, focus on history, accessible for younger kids). The localized media generation platform can generate one or more localized media experiences that the user is enabled to review prior to consuming the localized media experiences. The localized media experiences can be selected/generated based on the direction of the approach (e.g., eastbound versus westbound, time of day, weather, user-specific features, and so forth). In some cases, the AI model(s) select/generate experiences based on a user profile obtained beforehand (e.g., from user-input preferences). Moreover, dynamic experiences can trigger the generation of certain achievement notifications or digital collectibles (e.g., NFTs).

Further, the localized media generation platform can prompt users to select or be assigned (e.g., associated, linked, mapped) to a specific group (e.g., category, set) at the beginning of the experience or at particular points during the journey. The grouping can be based on various factors such as user preferences, skill levels, or randomly assigned teams for game-like experiences. For example, in a historical tour, a “Red Team” is presented with architectural details while a “Blue Team” explores social history to provide unique and/or different perspectives on the same locations.

The localized media generation platform can communicate with external application programming interfaces (APIs) that are specific to particular routes or geographic zones. The APIs can provide data such as weather conditions, traffic updates, or event schedules that dynamically influence the content presented to users. In some implementations, the data is provided in real-time or near-real-time. In other implementations, the data includes anticipated data that the localized media generation platform (e.g., via one or more AI models) uses to plan the localized media experience in advance. The data can be associated with future events, conditions, and/or circumstances that may impact the user's experience. For example, when generating a tour for a user planning a trip to Washington D.C. in June, the localized media generation platform can access city event calendars, traffic prediction models, and/or historical weather patterns. If the localized media generation platform identifies a scheduled parade during the user's visit, the localized media generation platform can preemptively adjust the proposed itinerary to avoid congested areas on the specific day of the event. In another example, an API connected to a museum's exhibition schedule can update available content based on current displays, while a wildlife park API can provide real-time animal sighting information. The activation of these external APIs can be triggered by user location, time of day, specific interactions, and so forth, within the experience.

Unlike conventional systems, the localized media generation platform can dynamically adjust the content (i.e., the localized media generation platform) to remove redundant information, add information or locations, and/or modify information and/or locations to ensure a contextually coherent experience (e.g., tour, storytelling, game) regardless of the order in which locations are visited. This localized media generation platform can also filter any existing locations which become unnecessary due to user preference and/or input. Further, by using AI models to generate the localized media generation platform based on interaction history, current location, movement patterns, and so forth, the localized media generation platform is enabled to customize the experience to a particular user or group of users. Not only does the localized media generation platform conserve computational resources, but the localized media generation platform avoids the disjointed and fragmented media experiences of conventional systems. The localized media generation platform also provides flexibility to the user in terms of location, time, customizability and use.

In some implementations, the localized media generation platform can change the content of other localized media experiences based on previous use (e.g., a previous localized media experience presented to the user). For instance, a user has completed a tour of a local dam and is doing another tour experience at a remote destination. The new localized media experience can change based on previous use history for that user. In some implementations, if the user is presented with a game experience, a previous localized media experience can “level up” the user to a variation in a new localized media experience.

While the current description provides examples of the AI models such as large language models (LLMs), one of skill in the art would understand that the disclosed techniques can apply to other forms of machine learning (ML) or algorithms, including unsupervised, semi-supervised, supervised, and reinforcement learning techniques and can use model outputs such as those generated using diffusion models.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Overview of the Localized Media Generation Platform

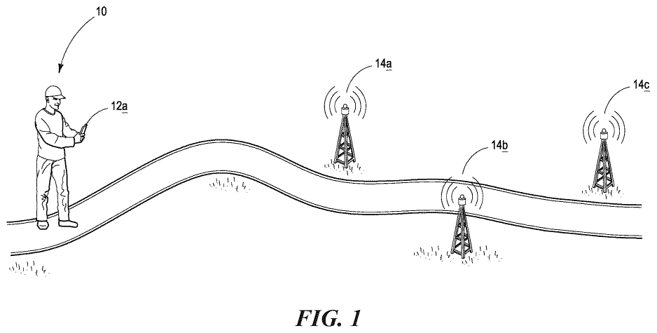

The present disclosure will be described with reference to FIGS. 1-25. Referring first to FIG. 1, a user 10 is shown using a device 12 in association with points 14a-14c. As shown in FIG. 1, this user is shown in relation to these points in a relatively straightforward alignment, wherein if user 10 proceeded down a path, it would first interact with 14a, then 14b, then 14c, in that order. The present disclosure provides systems and methods that allow user 10 to be directed (or lets the user choose direction), rather than a typical path from 14a to 14b, to 14c, for example, instead of from 14b to 14c, from 14b back to 14a, if in fact they want to return there. This is just one example of an implementation of the disclosure.

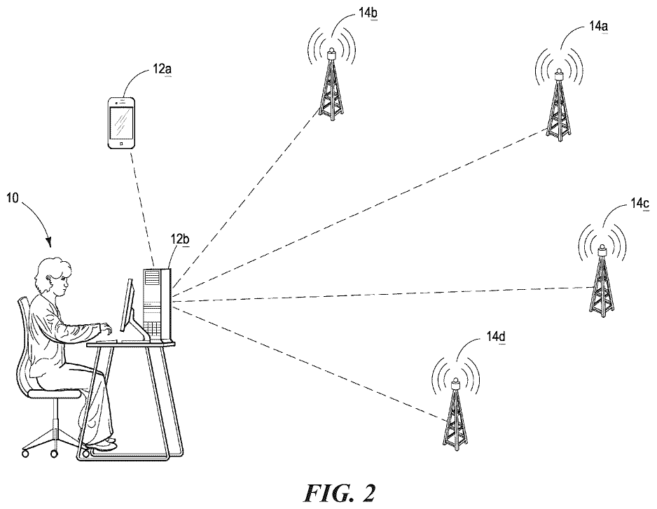

Referring to FIG. 2, a user 10 is associated with an operating system 12b that may be able to interface with device 12a. This operating system 12b may be able to communicate with points 14a through 14d, for example. As shown, these points may be hard wired and/or wirelessly connected to operating system 12b. Utilizing this format, operator 10 may be able to preprogram device 12a and/or preprogram points 14a through 14d, for example—or use device 12a to create/store data for points 14a through 14d.

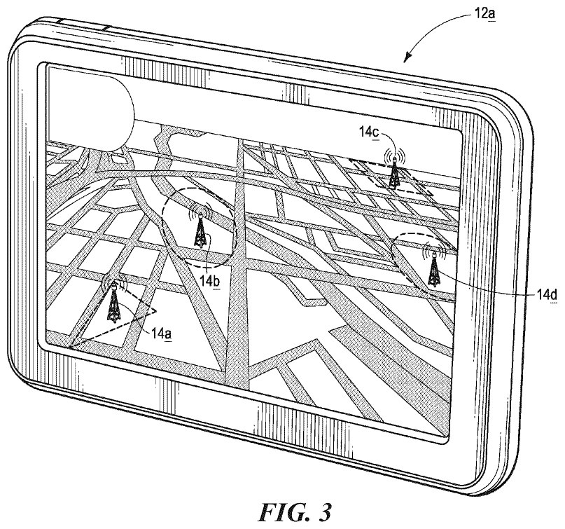

Referring next to FIG. 3, an interface of device 12a is shown that indicates points 14a through 14d plotted along a map or route. This plotting along a map or route may not be novel, however, providing zones within 14a through 14d that can trigger 12a to indicate that the user utilizing device 12a is in some form associated with one of the points, and then directing the user or allowing the user to move to another one of the points according to an implementation of the disclosure, is one example of the localized media generation platform of the present disclosure. Localized media can include an experience/tour of a collection of interesting data (or interests), relevant to the author's intent through operation. Operators' experiences may include music, sounds, text, pictures and/or video that change dynamically based on the locations as the operator moves. Using various region shapes/sizes, operators have more flexibility in a tour with this system.

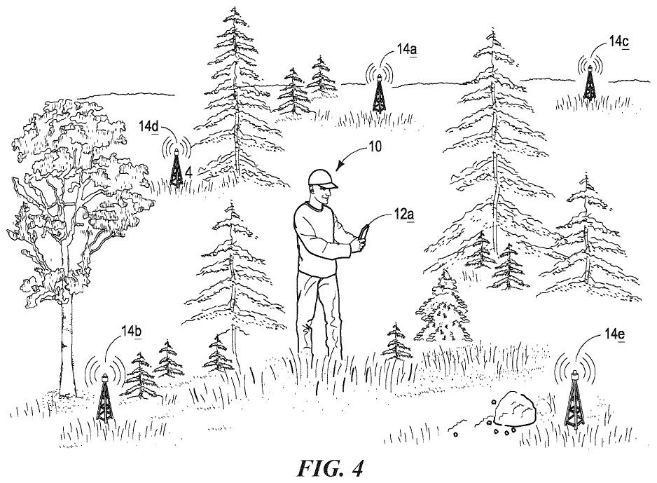

Referring next to FIG. 4, user 10 is shown utilizing device 12a in association with one or more of points 14a through 14e. In this manner of fashion, user 10 may be dynamically touring a backdrop such as a forest, for example, as shown in FIG. 4, and may be directed between points utilizing device 12a in an order inconsistent with a straightforward path as indicated in the prior art. According to example implementations, the user 10 can be directed from 14d, for example, back to 14c, or from 14d in a nonlinear fashion back to 14a, for example. This allows the experience to change based on the order at which the user moves through points 14a through 14e. A user at a crossing with a point of interest straight ahead, may choose to go left-resulting in a different but valid experience where the system and methods of the present disclosure (i.e., the localized media generation platform) would present data to the user with the appropriate location in context of their choice.

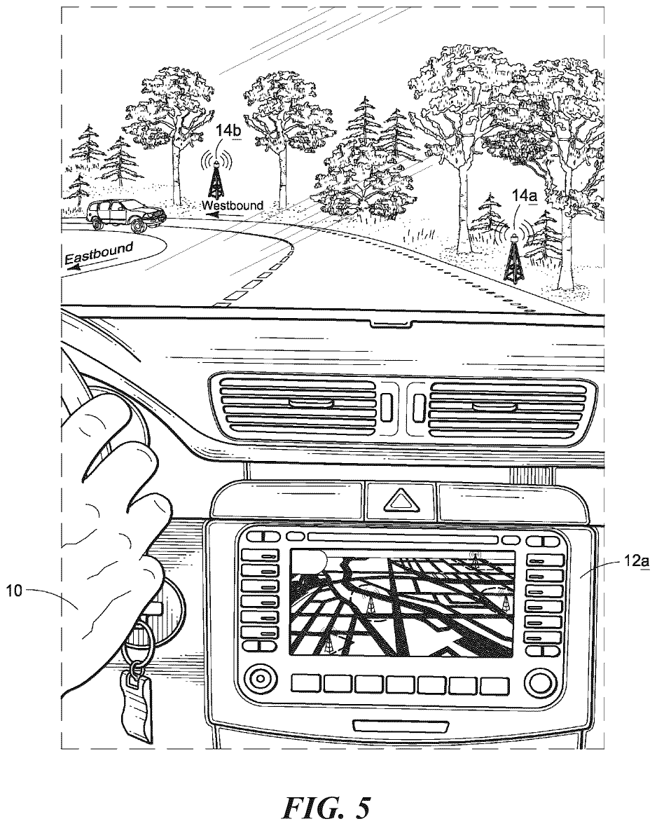

Referring next to FIG. 5, user 10 may be within a vehicle and within that vehicle may be a device 12a having an interface as shown. With this interface, user 10 may become associated with points 14a or 14b as shown, and may be directed to return or choose alternate routes along a tour predefined and/or dynamically controlled via user 10. The user driving eastbound will receive data in context reverse to the user driving westbound.

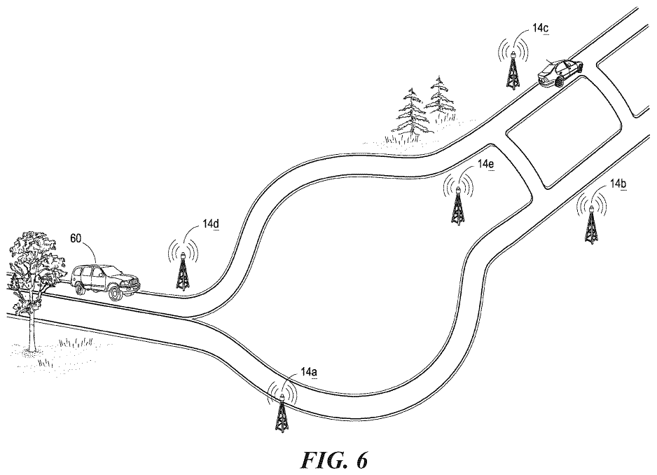

Referring to FIG. 6, an overview of an operator operating a vehicle such as vehicle 60 in relation to various pinpoints 14a-14e is shown. As can be seen, pinpoints 14a and 14d can be along alternative routes of a path or experience/tour. According to example implementations of the present disclosure, vehicle 60 being operated by an operator such as an operator 10 can be directed to return along these routes in directions that are nonlinear. For example, vehicle 60 may be directed to (or freely choose to) proceed to point 14c and then return via point 14b, 14e, or 14d, for example. The implementations are endless and are provided by dynamically controlling the direction of the experience/tour by the user and/or vehicle that is proceeding along the experience/tour.

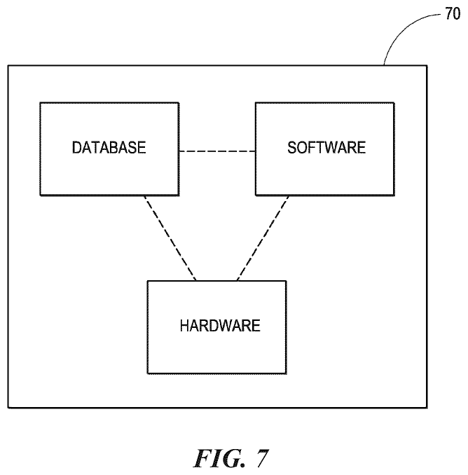

Referring next to FIG. 7, a system that may be utilized within the device is described herein can be exemplified as system 70. This processing circuitry 70 can include a database, software, and hardware in accordance with example implementations.

The localized media generation platform can include and utilize a processor. The processor can include personal computing system that includes a computer processing unit that can include one or more microprocessors, one or more support circuits, circuits that include power supplies, clocks, input/output interfaces, circuitry, and the like. Generally, all computer processing units described herein can be of the same general type. The computing system can include a memory that can include random access memory, read only memory, removable disc memory, flash memory, and various combinations of these types of memory. The memory can be referred to as a main memory and be part of a cache memory or buffer memory. The memory can store various software packages and components such as an operating system.

The computing system may also include a web server that can be of any type of computing device adapted to distribute data and process data requests. The web server can be configured to execute system application software such as the reminder schedule software, databases, electronic mail, and the like. The memory of the web server can include system application interfaces for interacting with users and one or more third party applications. Computer systems of the present disclosure can be standalone or work in combination with other servers and other computer systems that can be utilized, for example, with larger corporate systems such as financial institutions, insurance providers, and/or software support providers. The system (i.e., the localized media generation platform) is not limited to a specific operating system but may be adapted to run on multiple operating systems such as, for example, Linux and/or Microsoft Windows. The computing system can be coupled to a server and this server can be located on the same site as computer system or at a remote location, for example.

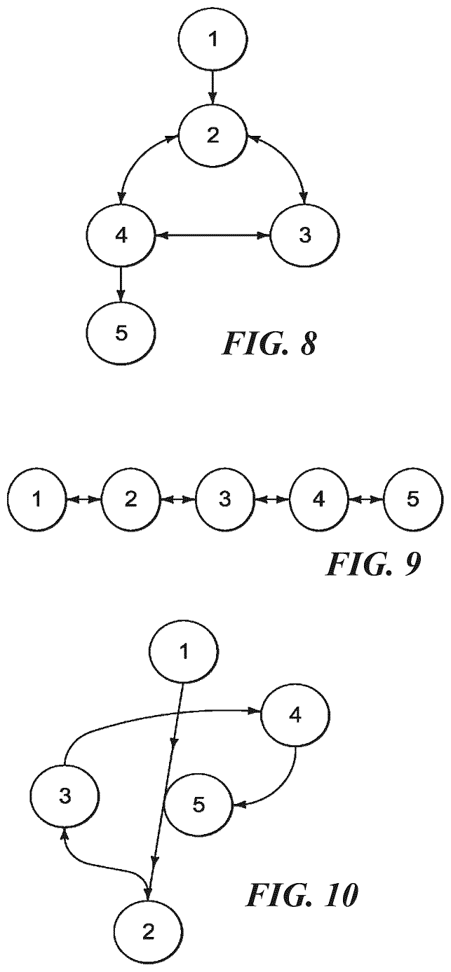

Referring next to FIGS. 8-10, example dynamic localized media options are shown in these figures. In accordance with FIG. 8, a dynamic localized media experience can be to proceed from location 1 to 2, and then alternatively choose between 3 or 4, and then upon proceeding to 3, then on to 4, or upon proceeding to 4, then on to 3. Accordingly, the dynamic localized media experience can end at 5, or may end at 3, for example, but typically may end at 5. In accordance with an example implementation, a linear experience/tour may be provided with respect to FIG. 9 as points proceed to 1, 2, 3, 4, and on to 5, in that order. The user may join the tour at 3 and head in reverse towards 2 and then onto 1. In accordance with another example and with respect to FIG. 10, another dynamic localized media tour route is provided between 1, 2, 3, on to 4, and then 5, but these routes can be disassociated with geographic proximity. As can be seen point 1 is closest to point 4; however, the dynamic tour may dictate that the furthest geographic distance may be better suited to provide the tour than the most proximate geographic distance. This system allows a non-linear geographic path in both an ordered or unordered experience. The user has the ability to move between points and the system (i.e., the localized media generation platform) can restrict providing data if the tour must be done in order; or allow the user to not be restricted in receiving data based on where the user proceeds between points. (For example, a scavenger hunt may need to cover each point in any order. A treasure hunt may need to build upon each previous find. As another example, the tour may be provided as part of a game, such as a video game, and/or as the game itself; providing a type of game-play mechanic that allows for various types of puzzles and/or a game that may be augmented according to the data associated with this platform.)

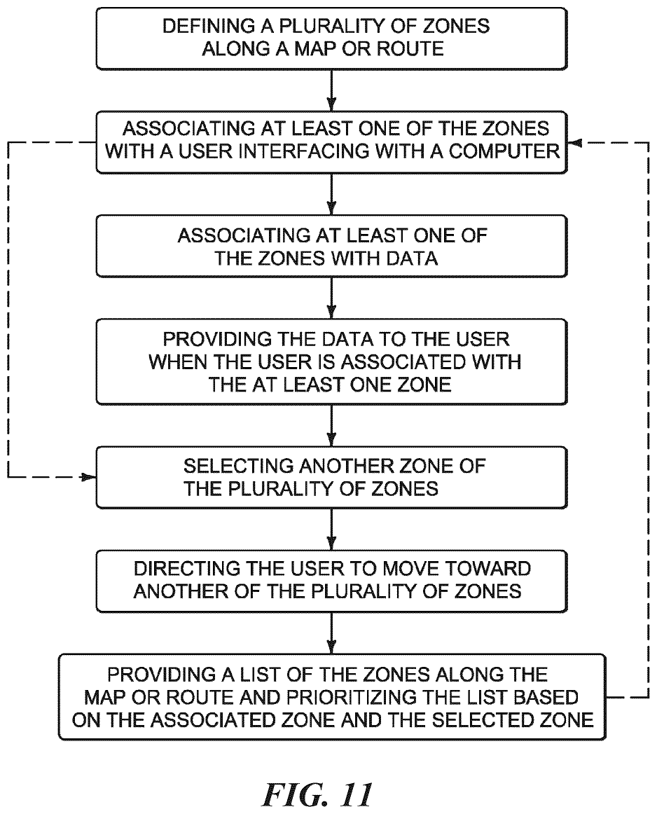

Referring to FIG. 11, a method for providing a computer aided tour is provided according to an implementation of the disclosure. The method can include creating, operating, sorting, managing and/or maintaining a collection of dynamically controlled localized media experiences and/or tours. The method can include defining a plurality of zones along a map or route. In the next operation, at least one of the zones can be associated with a user interfacing with a computer. The next operation can include selecting another zone of the plurality of zones. The selecting can be random and/or non-linear along the map or route. The selecting can be based on a profile established by the user.

Intermediate operations of the method can include associating the at least one of the zones with data and/or providing the data to the user when the user is associated with the at least one zone. The data is one or more of music, sound, text, pictures, and/or video, for example. The data can be acquired from a database associated with at least one zone. The data may vary depending on previously accessed zones and may influence the rest of the set of zone access. The zones may overlap in locations and only allow access by a sequence designated by the author.

In the next operation a list of the zones along the map or route can be developed and/or provided. The order of the zones can be prioritized based on the associated zone and the selected zone. The types of zones may also be filtered by location.

In a following operation, the user can be directed to move toward another of the plurality of zones, for example with the user interface. As the user may continue to any zone, the system (i.e., the localized media generation platform) will provide adjusted data dynamically.

In accordance with example implementations, operations of FIG. 11 for example may be skipped to subsequent operations and/or previous operations can be returned to from subsequent operations. As an example, after the operation of associating at least one of the zones with a user interfacing with a computer, the next operation may be selecting another zone of the plurality of zones. As another example, after providing a list of the zones along the map or route and prioritizing the list based on the associated zone and the selected zone, the next operation may be associating at least one of the zones with a user interfacing with a computer. Accordingly, the system (i.e., the localized media generation platform) can run in a continuous loop with the movement of the user in relation to the zones.

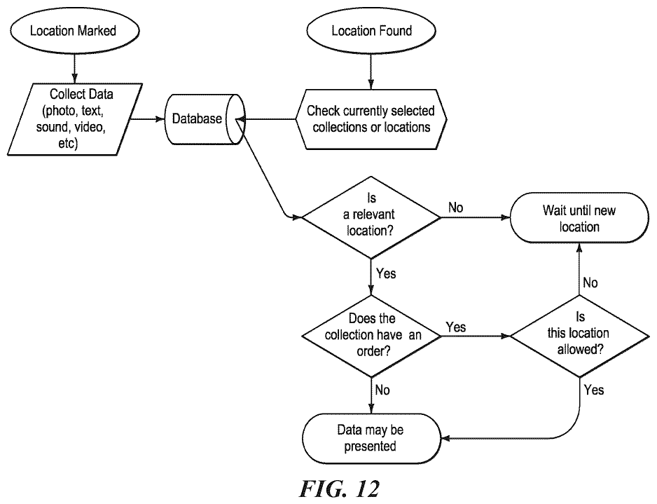

Referring to FIGS. 12-17, examples and processes for acquiring and/or processing data utilizing processing circuitry 70 are shown. In accordance with example implementations, these processes may be utilized in connection with the processing circuitry described to provide the dynamic localized media options. The processes may use software and/or hardware of the following combinations or types. For example, with respect to server-side languages, the circuitry may use Java, Python, PHP, .NET, Ruby, JavaScript, or Dart, for example. Some other types of servers that the systems may use include Apache/PHP, .NET, Ruby, NodeJS, Java, and/or Python. Databases that may be utilized are Oracle, MySQL, SQL, NoSQL, or SQLLite (for Mobile). Client-side languages that may be used, this would be the user side languages, for example, are ASM, C, C++, C #, Java, Objective-C, Swift, ActionScript/Adobe AIR, or JavaScript/HTML5. Communications between the server and client may be utilized using TCP/UDP Socket based connections, for example, as third-party data network services that may be used include GSM, LTE, HSPA, UMTS, CDMA, WiMax, WiFi, Cable, and DSL. The hardware platforms that may be utilized within processing circuitry 70 include embedded systems such as (Raspberry PI/Arduino), (Android, iOS, Windows Mobile)—phones and/or tablets, or any embedded system using these operating systems, i.e., cars, watches, glasses, headphones, augmented reality wear etc., or desktops/laptops/hybrids (Mac, Windows, Linux). The architectures that may be utilized for software and hardware interfaces include x86 (including x86-64), or ARM.

The server-side state management without client-side memory can process between the server and the client sides in the following manners. For example, in Operation 1, you can send server ID/marker/beacon for processing, collection ID, and unique device ID, and then Operation 2 would be to wait for data response (media; such as video, text, sound, etc.) or null response from the server. Beacons (also markers, locations, points) can include where data is associated to a unique location, not necessarily a physical device in that it may be a GPS coordinate or a unique sound or a computer identifiable code that can be scanned and interpreted, at said location, etc.

On the server side, Operation 1 would be to retrieve marker ID for processing, check against collection ID for data using unique device ID for history; Operation 2 would be to record device ID current/previous marker ID; Operation 3 would be to process next interest marker; and Operation 4 would be to return data response to client if available, null if none.

The server-side state management with client side memory can process between the server and the client sides in the following manners: Operation 1 can be to send server ID/marker/beacon for processing, collection ID, and unique device ID; Operation 2, wait for data marker ID response (ID of marker for media—sound/image/video/text—playback) or null response from server; and Operation 3, playback data marker ID response from device Memory. On the server side, Operation 1, retrieve marker ID for processing, check against collection ID for data using unique device ID for history; Operation 2, record device ID current/previous marker ID; Operation 3, process next interest marker; and Operation 4, return data marker ID response to client if available, null if none.

The client-side (collection information is downloaded and stored directly to the device, state processing is done locally and with or without need for external network connection) can process in the following manners: Operation 1, marker info processing; Operation 2, check if valid ID against collection stored memory; Operation 3, if valid ID, playback data from marker ID, if not, record marker change if necessary or ignore marker; and Operation 4, record marker change, wait for new marker.

Referring next to FIG. 12, according to one process, location can be marked and data collected, then stored in a database. A beacon can be found by many methods such as by stumbling across it and recognizing it visually, such as while proceeding down a tour, and/or the users device recognizing a beacon via QR Code, NFC, iBeacons, and/or sound signals. The process would include checking currently selected collections or locations and storing them in the database. A process can include determining whether it is a relevant location; if the answer is yes, then does the collection have an order that is associated with the location. If it does, then is the location allowed; if not, you would move on to a new location. If it is allowed, then data may be presented to the device from the location beacon such as 14a through 14e described herein.

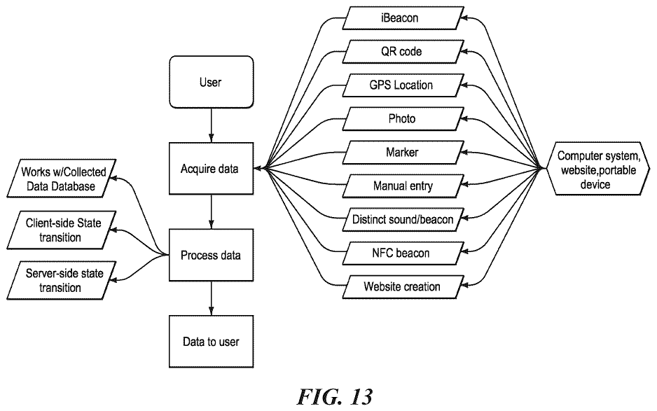

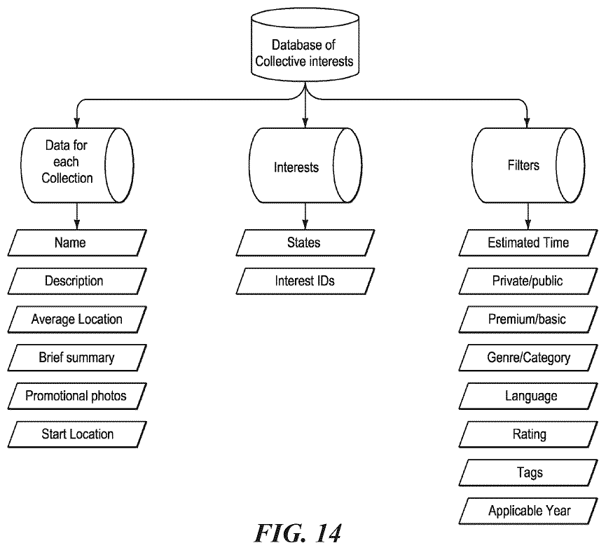

In FIGS. 13 and 14, examples of data collection within the database are described. From a client-side state transition and server-side state transition as described previously, iBeacon, QR code, GPS location, photo, marker, manual entry, distinct sound/beacons, NFC beacons, web site creation, these are all examples of points such as 14a through 14e that may be utilized to trigger a tour event that provide an operator with a different experience in their tour.

For example, the marker information can be a photo captured by a user's device. In this implementation, the localized media generation platform uses image recognition technology, such as TENSORFLOW or similar machine learning models, to identify specific elements within the captured photo. When a user takes a picture of a particular object, artwork, or scene, the localized media generation platform can compare it against a pre-defined set of visual markers associated with various localized media experiences. Upon recognition of a matching visual marker, the localized media generation platform triggers the activation of the corresponding beacon or initiates the delivery of a particular set of dynamic content. For example, the information can be used in scenarios such as scavenger hunts where users are tasked to find and photograph specific items to progress, or museum tours where capturing images of artworks unlocks information and/or storytelling about the pieces.

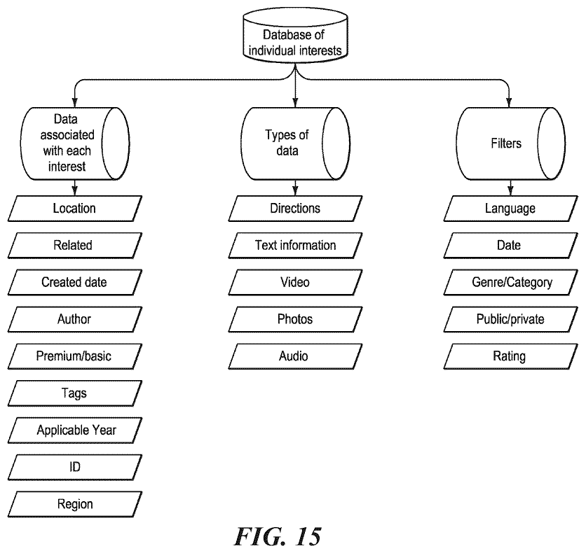

This data can be acquired by the device such as 10a shown and the data processed according to the client-side state transition or server-side state transition and entering data to the user. All of these beacons, QR codes, etc., can be preprogrammed utilizing a computer system, web site, portable device, such as that shown in FIG. 2 and disclosed as device 12b. In another example, one or more databases of collective interests can be provided. Now these are interests to the user that are associated with device 12a and can be preprogrammed in relation to device 12b and the beacons. Data for each collection of interests can include the name, description, average location, brief summary, promotional photos, start locations, for example. The interests can include states, interest IDs, for example, and filters may be utilized that can include estimated time, private/public, premium/basic, genre/category, language, rating, tags, applicable year. These filters can be utilized to provide a more searchable database of collective interests. Within the collective interests and referring to FIG. 15 is a database of individual interests. These individual interests can be associated with individual locations and/or users, for example, and can also include data associated with each interest, types of data, and/or filters. The data associated with each interest can include the location, related, created date, author, premium/basic, tags, applicable year, ID, and region. Types of data can include directions, text information, video, photos, and audio, for example. Filters can include language, date, genre/category, public/private, and/or rating, for example.

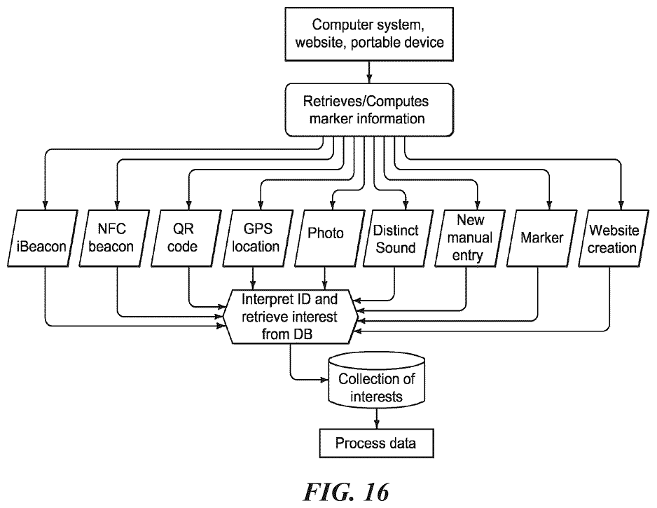

Referring next to FIG. 16, an example process for acquiring the data is shown that utilizes the computer system website portable device such as devices 10a or 10b shown herein. That system can retrieve/compute marker information that can include iBeacon, NFC beacon, QR code, GPS location, photo, distinct sound, new manual entry, marker, or website creation. The system (i.e., the localized media generation platform) can then interpret the ID and retrieve interests from the database, and the collection of interests as shown in FIG. 14 can be provided, and then processed.

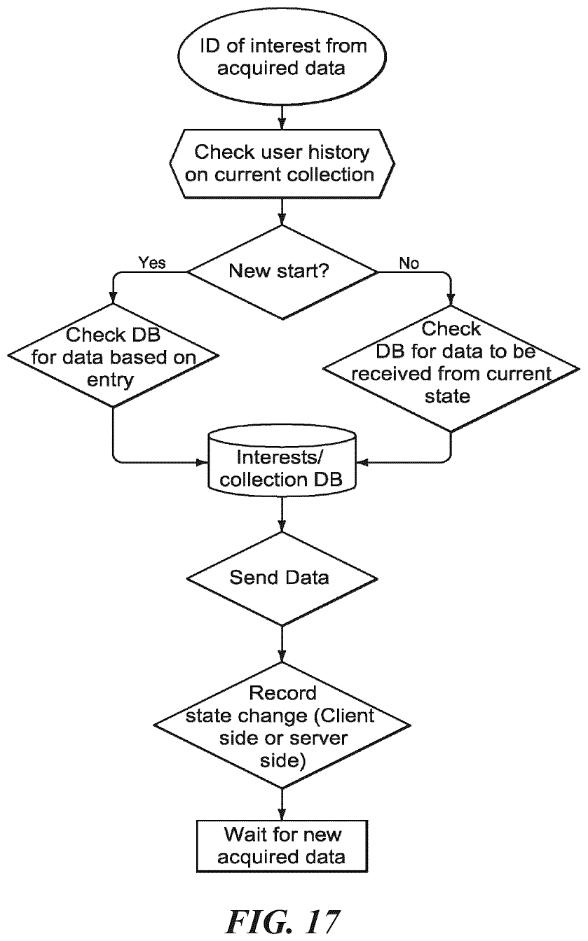

Referring lastly to FIG. 17, another process is shown that includes ID of interest from acquired data, checking the user history on current collection, and then determining whether or not to start. If a start is triggered, the database is checked for data based on entry, and then interests collected according to FIGS. 12 and 13, for example, and then the data is sent, and a record state change (client-side or server-side) is made. This is the direction change that takes the user to a new location rather than proceeding along a linear path. A user then simply waits for new acquired data. If the new start is a no, then the system (i.e., the localized media generation platform) returns to and checks the database for data to be received from current state. That current state is the device, whether it is being triggered via proximity to a point and/or initiated by the user.

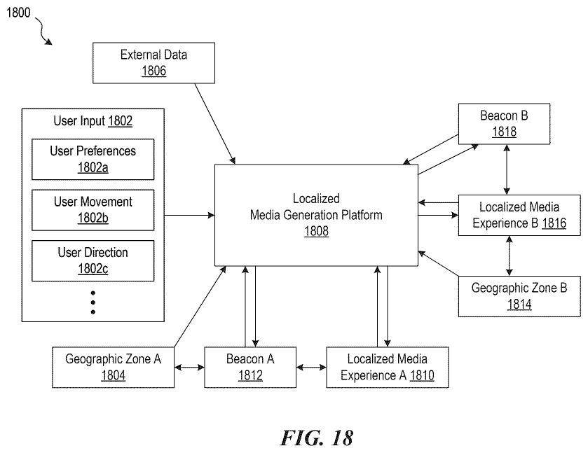

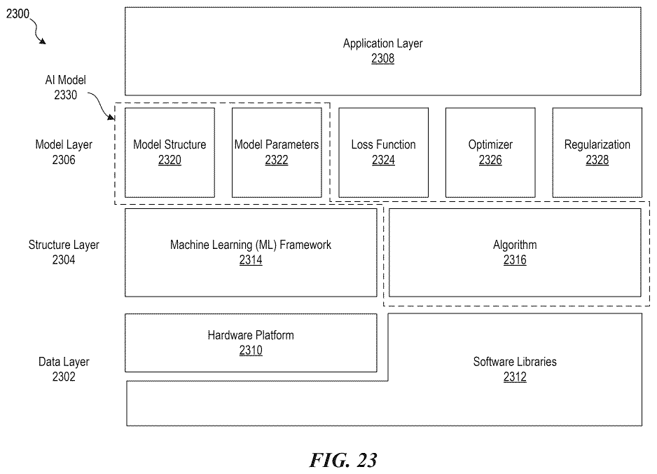

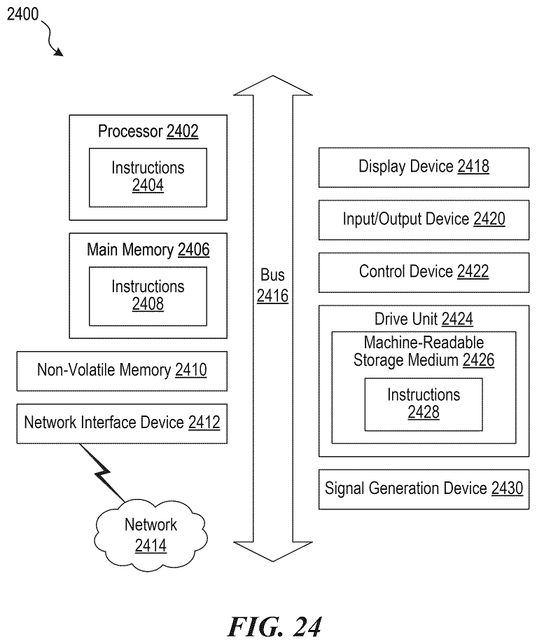

FIG. 18 illustrates an example environment 1800 of dynamically generating localized media experiences using a localized media generation platform 1808 while a user moves through different geographic zones, in accordance with some implementations of the technology. The example environment 1800 includes user input 1802 (which can include user preferences 1802A, user movement 1802B, user direction 1802C, and so forth), a first geographic zone 1804, external data 1806, a first localized media experience 1810, a first beacon 1812, a second geographic zone 1814, a second localized media experience 1816, and a second beacon 1818. The localized media generation platform 1808 can include one or more models that are the same as or similar to AI system 2300, illustrated and described in more detail with reference to FIG. 23. The localized media generation platform 1808 can be implemented using components of example computer system 2400 illustrated and described in more detail with reference to FIG. 24. Implementations of example environment 1800 can include different and/or additional components or can be connected in different ways.

In some implementations, the localized media generation platform 1808 can use the user input 1802, the first geographic zone 104 (e.g., a geographic zone that a user is located in), and/or the external data 1806 to generate the first localized media experience 1810. The user input 1802 refers to one or more data streams received by the computing device (e.g., the computer system 2400 in FIG. 24), such as user preferences 1802A (e.g., content categories, experience durations, difficulty levels), user movement 1802B (e.g., velocity vectors, acceleration patterns, mode of transportation), user direction 1802C (e.g., compass heading, planned waypoints), and so forth. The computing device can be a user device (e.g., mobile phone, tablet, smartwatch, AR glasses, etc.) or a device that is associated with a user by virtue of a user/user device being in communication with it (e.g., via a Bluetooth connection or other NFC means, beacon etc.). The user input 1802 can be collected in real-time or near-real time through various sensors such as GPS, accelerometers, and gyroscopes, as well as explicit user settings and historical data (e.g., historically visited waypoints, historical durations in a particular geographic zone).

Geographic zones 1804 and 1814 represent distinct spatial regions defined by geofences, GPS coordinates, and/or proximity to specific beacons. Each zone can have associated metadata including topographical information, points of interest density, and semantic labels (e.g., “historical district”, “nature trail”). In some implementations, the geographic zones 1804 and 1814 overlap or have fuzzy boundaries to enable smooth transitions between experiences. External data 1806 includes real-time, near-real-time, and/or static information from third-party APIs and databases. The external data 1806 can include, for example, weather conditions (temperature, precipitation, UV index), event schedules, traffic patterns, and so forth, that are associated with the geographic zones 1804 and 1814.

The localized media generation platform 1808 uses one or more AI models (e.g., LLMs) to generate the first localized media experience 1810. The first localized media experience 1810 can refer to customized and/or interactive content dynamically generated based on the user's current location, preferences, and/or environmental context. The first localized media experience 1810 can include various forms of media such as audio narrations, visual overlays, interactive games, informative text, and so forth.

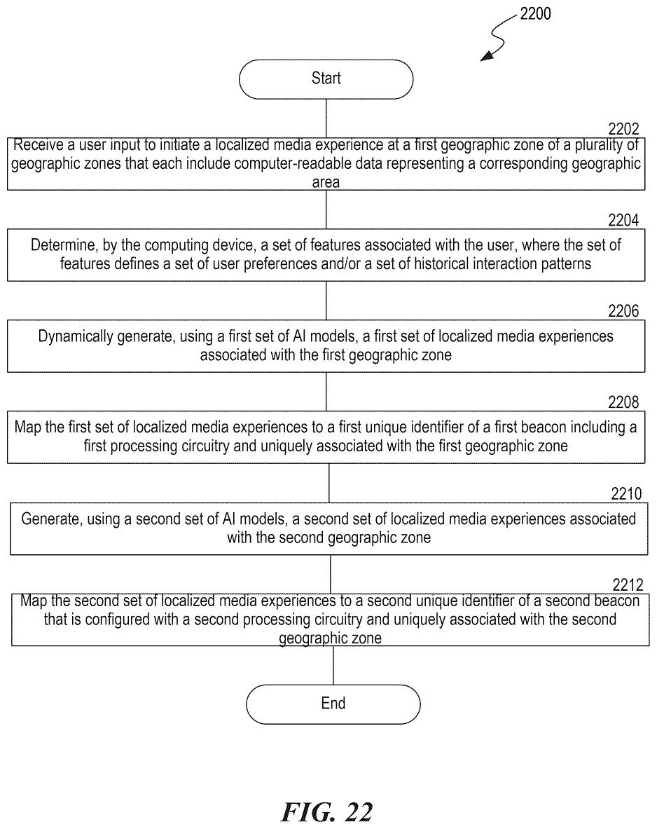

In some implementations, the user input 1802, first geographic zone 1804, and external data 1806 are vectorized and embedded (e.g., using an embedding model) into a high-dimensional feature space. The localized media generation platform 1808 uses the embeddings as input to one or more AI models to generate the first localized media experience 1810. The AI models can include transformer-based language models (e.g., to generate text), convolutional neural networks (CNNs), recurrent neural networks (RNNs), and so forth. For example, a transformer model can be trained on a corpus of location-specific historical texts to generate narratives about points of interest within the first geographic zone 1804, while another AI model can be trained to suggest personalized routes or activities. Methods of generating the first localized media experience are further discussed with reference to FIG. 22.

The localized media generation platform 1808 can link the first localized media experience 1810 to the first beacon 1812. The first beacon 1812 refers to a physical or virtual marker that operates as a trigger point for delivering the localized media experience 1810 to the user. The first beacon 1812 can be structured as, for example, a Wi-Fi access point, a GPS coordinate, a visual marker such as a QR code, and so forth. When a user's device detects proximity to the first beacon 1812, the first beacon 1812 triggers the platform to initiate and/or generate the first localized media experience 1810. Beacons can be placed to create a network of experience trigger points to enable a continuous and coherent narrative/interactive experience across the geographic zones.

As users transition between zones (e.g., from the first geographic zone 1804 to the second geographic zone 1814), the localized media generation platform 1808 can generate the second localized media experience 1816 and associate the second localized media experience 1816 with the second beacon 1818 to enable the user to experience the second localized media experience 1816 at the second geographic zone 1814. For example, as the user moves from one geographic zone to another, the localized media generation platform 1808 uses the second geographic zone 1814, the first localized media experience 1810, and/or updated user input 102 and external data 1806 as the input for one or more AI models (e.g., an LLM) to dynamically generate the second localized media experience 1816 for the geographic zone 1814. The second localized media experience 1816 can build upon elements from the first localized media experience 1810 to ensure narrative continuity. The association of the second localized media experience 1816 with the second beacon 1818 is the same as or similar to the association of the first localized media experience 1810 with the first beacon 1812.

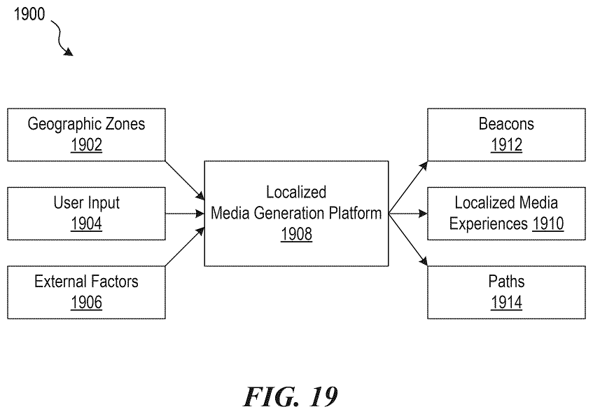

FIG. 19 illustrates an example environment 1900 of dynamically generating localized media experience variations using a localized media generation platform 1908 (same as or similar to the localized media generation platform 1808 in FIG. 18) before a user moves through different geographic zones, in accordance with some implementations of the technology. The example environment 1900 includes geographic zones 1902, user input 1904, external factors 1906, localized media experiences 1910, beacons 1912, and path 1914. The localized media generation platform 1908 can include one or more models that are the same as or similar to AI system 2300, illustrated and described in more detail with reference to FIG. 23. The localized media generation platform 1908 can be implemented using components of example computer system 2400 illustrated and described in more detail with reference to FIG. 24. Implementations of example environment 1900 can include different and/or additional components or can be connected in different ways.

The example environment 1900 is enabled to generate personalized media experiences before a user traverses different geographic zones (e.g., in scenarios with limited or no Internet connectivity). The localized media generation platform 1908 receives inputs from one or more data streams, such as geographic zones 1902 (e.g., geographic zones 1804 and 1814 in FIG. 18), user input 1904 (e.g., user input 1802 in FIG. 18), external data 1906 (e.g., external data 1806 in FIG. 18), and so forth. Geographic zones 1902 can include data representing physical areas that a user is planning to be located at (e.g., a particular neighborhood, park, museum, zoo, and so forth).

The localized media generation platform 1908 can vectorize the inputs into high-dimensional feature representations. These embeddings can be used as input to one or more AI models to generate one or more localized media experiences 1910. For example, a language model can generate multiple narrative variations for each point of interest depending on a route taken by the user. In another example, a computer vision model can generate one or more augmented reality overlays for various weather conditions or times of day. The localized media generation platform 1908 can associate the pre-generated experiences with specific beacons 1912 (same as or similar to the beacons 1812 and 1818) distributed throughout the geographic zones 1902. Each beacon can be linked to a set of pre-generated experiences to enable offline content delivery when a user approaches a corresponding beacon.

In some implementations, the localized media generation platform 1908 pre-generates one or more paths 1914 a user can take through the geographic zones 1902. For example, for each path, the localized media generation platform 1908 can prepare a sequence of localized media experiences that maintain narrative coherence and thematic relevance across zone transitions. Depending on which path the user takes, the sequence of localized media experiences can vary. To manage the use of computational resources, the localized media generation platform 1908 can progressively load the localized media experiences 1910. Particular content (e.g., introductory experiences for each zone) can be fully pre-generated, while other content can be prepared as templates with placeholders for real-time or near-real-time customization. The pre-generated localized media experiences 1910 can be stored on the user's device or in local edge computing nodes near the geographic zones. Thus, even in areas with poor connectivity, users can access dynamically generated content with minimal (or otherwise reduced) latency.

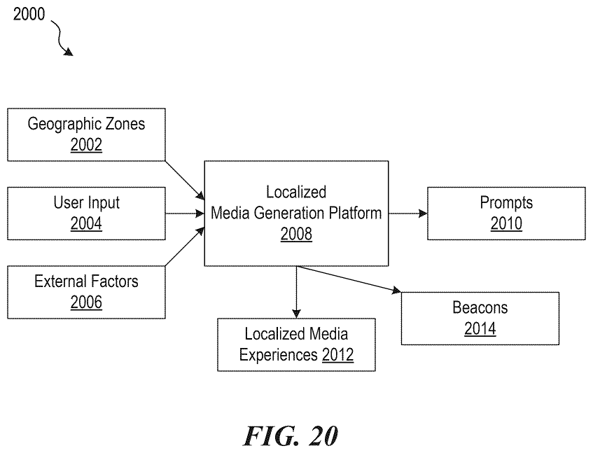

FIG. 20 illustrates an example environment 2000 of dynamically generating command sets associated with localized media experience variations using a localized media generation platform before a user moves through different geographic zones, in accordance with some implementations of the technology. The example environment 2000 includes geographic zones 2002, user input 2004, external factors 2006, prompts 2010, localized media experiences 2012, and beacons 2014. The localized media generation platform 2008 can include one or more models that are the same as or similar to AI system 2300, illustrated and described in more detail with reference to FIG. 23. The localized media generation platform 2008 can be implemented using components of example computer system 2400 illustrated and described in more detail with reference to FIG. 24. Implementations of example environment 2000 can include different and/or additional components or can be connected in different ways.

In some implementations, the localized media generation platform 2008 is enabled to pre-generate prompts or command sets that can be used to dynamically generate localized media experiences in real-time with reduced latency (e.g., in scenarios where immediate content generation may be computationally intensive or where network connectivity may be limited). The localized media generation platform 2008 can receive input associated with, for example, geographic zones 2002 (e.g., the geographic zones 1804, 1814, and 1902), user input 2004 (e.g., the user input 1802 and 1904), external factors 2006 (e.g., the external factors 1806 and 1906), and so forth. The localized media generation platform 2008 can vectorize the inputs and use the embeddings as input into one or more AI models to generate a set of prompts 2010. The prompts 2010 (e.g., command set, input, query) refer to pre-generated instructions or templates that can be subsequently used as input into one or more AI models to generate the localized media experiences 2012.

The pre-generated prompts 2010 can be associated (e.g., linked, mapped) with specific beacons 2014 (e.g., beacons 1812, 1818, and 1912) distributed throughout the geographic zones 2002. When a user approaches a beacon, the localized media generation platform 2008 can use one or more pre-generated prompts to dynamically generate a customized localized media experience 2012. For example, a prompt can include a narrative template with placeholders for location names, historical facts, or user-specific information. By pre-generating the prompts 2010, the localized media generation platform 2008 can reduce the latency associated with generating a full localized media experience when a user reaches a specific location. Additionally, by storing compact prompts 2010 rather than full localized media experiences, the localized media generation platform 2008 can conserve storage space and network bandwidth.

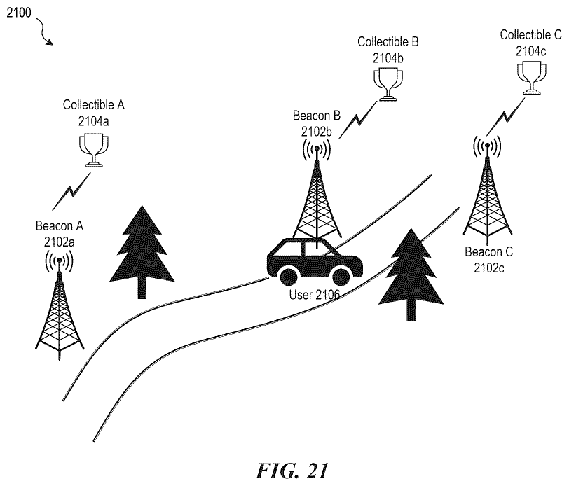

FIG. 21 illustrates an example environment 2100 of linking a digital collectible to a user based on the user interacting with a particular localized media experience using a localized media generation platform (e.g., the localized media generation platform of FIGS. 1-20, and 22-25), in accordance with some implementations of the technology. The example environment 2100 includes beacons 2102 (e.g., a first beacon 2102A, a second beacon 212B, a third beacon 2102C, and so forth), collectibles 2104 (e.g., a first collectible 2104A, a second collectible 1204B, a third collectible 1204C, and so forth), and a user 2106. The environment 2100 can include one or more models that are the same as or similar to AI system 2300, illustrated and described in more detail with reference to FIG. 23. The environment 2100 can be implemented using components of example computer system 2400 illustrated and described in more detail with reference to FIG. 24. Implementations of the example environment 2000 can include different and/or additional components or can be connected in different ways.

Dynamic localized media experiences can trigger the generation and linkage of digital collectibles, such as non-fungible tokens (NFTs), to users/user profiles based on the users' interactions and/or achievements predefined by the localized media generation platform (e.g., triggering digital rewards for participating in and/or completing various localized media experiences). For example, the user 2106 interacts with localized media experiences triggered by proximity to beacons 2102 (e.g., same as or similar to beacons 1812, 1818, 1912, and 2014). As the user moves through different zones and engages with the content provided by the localized media generation platform, the localized media generation platform can identify and store an indication of the geographic zones and/or localized media experiences participated in and/or completed by the user. In FIG. 21, for example, since the user is located near the second beacon 2102B, the localized media generation platform can trigger a notification or generation/linkage of the second collectible 2104B to the user 2106.

When predefined criteria are met, the localized media generation platform can trigger the generation of a notification and/or a digital collectible 2104. Digital collectibles 2104 can refer to virtual data, including unique digital artworks, badges, and/or tokens representing achievements within the localized media experiences. The digital collectibles 2104 can be generated dynamically and can indicate specific localized media experience(s) the user has participated in/completed. For example, a collectible can include stylized digital representation of a landmark the user has visited, and can be dynamically generated/modified to include attributes based on the time of day or specific actions taken during the experience.

In some implementations, each digital collectible 2104 is associated with a unique identifier and metadata that includes one or more attributes of the digital collectible, such as timestamps, location data, specific interaction metrics, and so forth. In some implementations, the localized media generation platform can use smart contracts to automate the process of minting and distributing collectibles. The smart contracts can define a set of conditions for awarding collectibles, such as completing a series of related experiences or achieving a certain degree of engagement across multiple locations. Users can view and manage their collected digital items through a user interface (e.g., a graphical user interface) of a computing device associated with the localized media generation platform. The interface can display information about each digital collectible, such as its rarity, the specific achievement it represents, options for displaying or sharing the item, and so forth. The localized media generation platform can enable users to compare their collections with friends or other participants. The interface can link one or more titles to a user and display unique achievements or accomplishments of the user (e.g., a rare title such as “Everest Climber”).

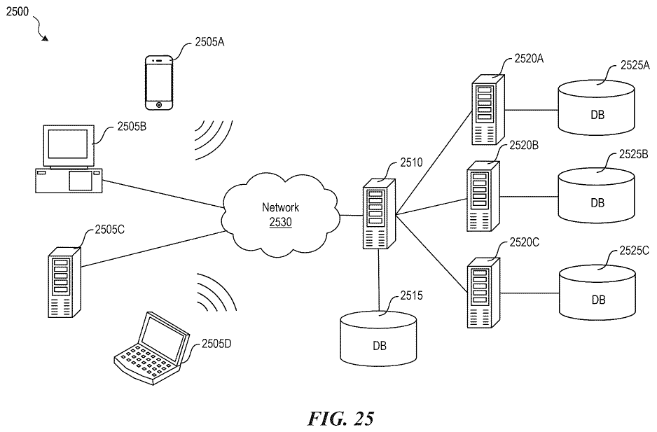

FIG. 22 is a flow diagram illustrating a process 2200 of dynamically generating localized media experiences using the localized media generation platform (e.g., the localized media generation platform of FIGS. 1-21, and 23-25), in accordance with some implementations of the technology. In some implementations, the example process 2200 is performed by a system (e.g., the localized media generation platform) including components of the example computing environment 2500 illustrated and described in more detail with reference to FIG. 25. The system can be implemented on a terminal device, on a server, or on a telecommunications network core. Likewise, implementations can include different and/or additional operations or can perform the operations in different orders.

In operation 2202, the localized media generation platform receives (e.g., at a computing device associated with a user) a user input to initiate a localized media experience at a first geographic zone of a plurality of geographic zones that each include computer-readable data representing a corresponding geographic area. The computing device associated with the user can be a smartphone, tablet, wearable device, or other computing system enabled to determine its geographic location or activated via other mentioned beacon technologies. The user input can be enabled through, for example, a tapping of a button in a mobile application, speaking a voice command, entering a predefined geographic area with location services enabled on the device, and so forth. The first geographic zone can be defined by specific GPS coordinates, geofencing boundaries, or proximity to a beacon (e.g., beacon 2102A in FIG. 21). The computer-readable data representing the physical geographic area can include points of interest, historical data, and/or other contextual information associated with the specific location.

In some implementations, the zones correspond to virtual locations. For example, the localized media generation platform can be adapted to operate within virtual reality (VR) environments. In a VR setting, geographic zones can be defined as specific areas within a virtual world, e.g., each with its own unique identifiers and associated content. As users navigate through the virtual spaces, the localized media generation platform can dynamically generate and deliver localized media experiences tailored to their virtual location, movement patterns, interactions, and so forth within digital landscapes. The AI models can use the user's virtual position (e.g., spatial coordinates), gaze direction, and interactions with virtual objects to trigger particular content/media experiences. For example, in a historical VR tour, approaching a virtual landmark activates a personalized narrative or interactive elements specific to that location.

In operation 2204, the localized media generation platform determines, by the computing device, a set of features associated with the user, where the set of features defines a set of user preferences and/or a set of historical interaction patterns. User preferences can include, for example, preferred content types (e.g., historical information, nature facts, local cuisine), preferred media formats (e.g., audio narrations, visual overlays, interactive quizzes), language preferences, accessibility requirements, and so forth. Historical interaction patterns can be derived from the user's past engagements with the localized media generation platform (e.g., frequently visited location types, average duration spent at different points of interest, preferred times of day for certain activities, patterns of movement between locations). The patterns can be identified, for example, using a clustering algorithm (e.g., k-means clustering, hierarchical clustering, density-based spatial clustering of applications with noise (DBSCAN)) to group users with similar preferences. For instance, the localized media generation platform can identify clusters of users who prefer audio-based experiences, those who engage more with visual content, and so forth. When the user initiates the experience, the localized media generation platform can capture external information, such as time of day, current weather conditions, and so forth (as shown by external data us 1806, 1906, and 2006) through one or more APIs.

In operation 2206, the localized media generation platform dynamically generates (e.g., using a first set of AI models) a first set of localized media experiences associated with the first geographic zone. The set of localized media experiences can include an interactive tour, a game, an interactive storytelling experience, and so forth. In some implementations, generating the set of localized media experiences is based on a previously visited location of the user, a set of operating hours associated with the plurality of geographic zones, a proximity to an additional computing device, a degree of Internet connectivity of the computing device, and so forth.

For example, the localized media generation platform can map the set of features associated with the user to a latent space to generate a set of feature vectors representative of the set of features. The localized media generation platform inputs the set of feature vectors into one or more input nodes of the first set of AI models to output, from one or more output nodes of the first set of AI models, the first set of localized media experiences. The distance between a vector representation of each localized media experience within the first set of localized media experiences and the set of feature vectors can satisfy a predetermined threshold (e.g., a predefined distance). If the distance is within a particular range (e.g., below a predefined distance), it can indicate that the generated experience aligns with the user's preferences and context. If a generated localized media experience falls outside the threshold, the localized media generation platform can discard it and generate a new localized media experience, or adjust the localized media experience to reduce the distance.

In some implementations, the localized media generation platform causes communication with one or more external APIs associated with the particular geographic zone to retrieve additional contextual data, and the particular localized media experience can be selected based on the additional contextual data. For example, in some implementations, the localized media generation platform obtains a set of user variability parameters defining a set of user groups. The localized media generation platform assigns the user to a specific user group within the set of user groups based on a degree of satisfaction of the set of features of the user with one or more user variability parameters of the set of user variability parameters. The localized media generation platform can select the particular localized media experience and/or the particular experience combination based on the specific user group assigned to the user.

In operation 2208, the localized media generation platform maps the first set of localized media experiences to a first unique identifier of a first beacon including a first processing circuitry and uniquely associated with the first geographic zone. Each localized media experience in the first set of localized media experiences can be accessible by the computing device based on a first proximity between the computing device and the first beacon. The beacon's first processing circuitry can include components such as a microcontroller, memory, and a communication module. For example, the localized media generation platform can generate entries in a database that links the beacon's unique identifier with the corresponding set of localized media experiences. The database could be stored centrally on the localized media generation platform's servers and/or distributed to edge devices. Additionally, the localized media generation platform can use webhooks upon user activation of a beacon to enable near-real-time or real-time communication with external systems, and/or triggering specific events within the experience.

In operation 2210, responsive to determining that the user has relocated to a second geographic zone of the plurality of geographic zones, the localized media generation platform automatically generates, using a second set of AI models (same as or different from the first set of AI models), a second set of localized media experiences associated with the second geographic zone using the first set of localized media experiences, a direction of movement of the user, and/or a pattern of movement of the user. In some implementations, the first set of localized media experiences and the second set of localized media experiences includes music, sounds, text, pictures, and/or video data. In some implementations, the first set of AI models and the second set of AI models include one or more encoder-decoder architectures that project the set of feature vectors into a shared latent space and reconstruct the set of feature vectors into media experience representations.

In some implementations, the second set of localized media experiences is generated by inputting the set of feature vectors into one or more input nodes of the second set of AI models to output, from one or more output nodes of the second set of AI models, the second set of localized media experiences. The distance between a vector representation of each localized media experience within the second set of localized media experiences and the set of feature vectors can satisfy the same or different predetermined threshold. In some implementations, the localized media generation platform determines, by the computing device, a set of pre-loaded query context associated with the user. The set of pre-loaded query context can define a collection of predefined prompts used by the AI models to generate the first set of localized media experiences and the second set of localized media experiences based on a user category and/or a set of historical user queries.

In operation 2212, the localized media generation platform maps the second set of localized media experiences to a second unique identifier of a second beacon that is configured with a second processing circuitry and uniquely associated with the second geographic zone. Each localized media experience in the second set of localized media experiences can be accessible by the computing device based on a second proximity between the computing device and the second beacon. In some implementations, the localized media generation platform causes presentation of the first set of localized media experiences through the computing device, and causes presentation of the second set of localized media experiences through the computing device.

The localized media generation platform can provide users with a visual representation of their generated experiences by overlaying them onto an interactive map. Thus, the users are enabled to understand available points of interest and their spatial relationships. For example, the map interface can display icons or markers representing each beacon or zone that can be color-coded to indicate different types of experiences or content categories. Users can interact with these markers to preview brief summaries of the available content at each location. The map can, in some implementations, visualize suggested routes or paths, to show how different paths may lead to varied content sequences. The localized media generation platform can present the generated experiences as a series of scrollable or swipeable tiles, where each tile represents a point of interest or content piece (e.g., a media experience). The tiles can be organized chronologically, by theme, or based on the AI's recommended sequence. Users can page through these tiles to review content summaries, estimated durations, and/or any prerequisites or connections between different experiences.

To pre-generate experience variations in the case of, for example, limited Internet connectivity (further discussed with reference to FIG. 19), the localized media generation platform can receive, at a computing device associated with a user, a user input to initiate a localized media experience at a plurality of geographic zones that each include computer-readable data representing a corresponding physical geographic area. The localized media generation platform determines, by the computing device, a set of features associated with the user, and dynamically generates, using a first set of AI models, a set of localized media experiences associated with the plurality of geographic zones. For example, the localized media generation platform can, for each geographic zone, map the set of features associated with the user to a latent space to generate a set of feature vectors representative of the set of features. The localized media generation platform inputs the set of feature vectors into one or more input nodes of the first set of AI models to output, from one or more output nodes of the first set of AI models, one or more localized media experiences of the set of localized media experiences. The localized media generation platform can dynamically generate, using the set of localized media experiences associated with the plurality of geographic zones, a set of experience combinations defining an ordered or partially ordered set of localized media experiences selected from different geographic zones within the plurality of geographic zones.

In some implementations, the ordered or partially ordered set of localized media experiences can function as an itinerary for the user. The AI-generated itinerary can provide a structured sequence of experiences across multiple geographic zones as a personalized tour or travel plan. The localized media generation platform can use parameters such as time management and thematic coherence when arranging the experiences. For instance, the localized media generation platform can organize historical sites chronologically, group culinary experiences by cuisine type, or structure nature-based activities to coincide with ideal viewing times. The itinerary-like structure can include estimated durations for each experience, suggested transition times between locations, recommendations for breaks or meals, and so forth. Users can be enabled to review and modify this AI-generated itinerary before or during their journey (e.g., on a computing device).

Responsive to determining that the user is located at a particular geographic zone of the plurality of geographic zones, the localized media generation platform can select a particular localized media experience within the set of localized media experiences and/or a particular experience combination based on the particular localized media experience. The particular localized media experience can be selected based on a proximity between the computing device and a corresponding beacon of the particular localized media experience, a direction of movement of the user, and/or historical localized media experiences previously presented on the computing device. The localized media generation platform can similarly cause presentation of the particular localized media experience on the computing device.

To pre-generate prompts (e.g., command sets, queries, and so forth) that can be used by an AI model to generate experience variations in the case of, for example, limited Internet connectivity (further discussed with reference to FIG. 20), the localized media generation platform can receive, at a computing device associated with a user, a user input to initiate a localized media experience at a plurality of geographic zones that each include computer-readable data representing a corresponding physical geographic area. The localized media generation platform can determine, by the computing device, a set of features associated with the user. The localized media generation platform can dynamically generate, using a first set of AI models, a set of command sets, each of which can cause a second set of AI models to generate a corresponding set of localized media experiences associated with one or more geographic zones. For example, the localized media generation platform maps the set of features associated with the user to a latent space to generate a set of feature vectors representative of the set of features. The localized media generation platform can input the set of feature vectors into one or more input nodes of the first set of AI models to output, from one or more output nodes of the first set of AI models, one or more command sets of the set of command sets.

Responsive to determining that the user is located at a particular geographic zone of the plurality of geographic zones, the localized media generation platform can select a particular command set within the set of command sets based on the particular geographic zone of the user, a direction of movement of the user, historical command sets previously input into the second set of AI models, and so forth. Generating/selecting the particular command set and/or a localized media experience can be based on a direction of approach to the particular geographic zone, a time of day, a weather condition, and so forth. For example, the localized media generation platform can use weather conditions, including minimum and maximum temperature thresholds, as well as specific weather types such as rain, snow, or clear skies. The localized media generation platform can adjust content based on the user's age to provide age-appropriate information or experiences. Time-based factors can further modify the content (e.g., the current time, day of the week, or specific dates).

The localized media generation platform can dynamically generate, using the second set of AI models, a set of localized media experiences using the particular command set wherein the set of localized media experiences are associated with a unique identifier of a beacon that is configured with a processing circuitry and uniquely associated with the particular geographic zone. Similarly, the localized media generation platform can cause presentation of the set of localized media experiences on the computing device. In some implementations, the localized media generation platform restricts the display for media content and triggers presentation of the particular localized media experience responsive to satisfying a set of criteria, such as a predetermined time period, a length of an audio segment, a first duration of time the user is located within the particular geographic zone, and/or a second duration of time since a presentation of a previous localized media experience. For example, the localized media generation platform can limit the duration of display until the user leaves a specific area, a predetermined time expires, an audio segment finishes playing, and so forth. In some implementations, localized media activation can be delayed upon entry to a new zone to enable users to acclimate to their surroundings before receiving new information. The localized media generation platform can include minimum time restrictions between activations of different locations to ensure that users have adequate time to engage with each experience before moving on or the minimum time restriction could be used for race timings between the plurality of zones.

The localized media generation platform can modify the set of features of the user based on a set of user interactions with the set of localized media experiences. In some implementations, the localized media generation platform receives a user request to add, modify, or remove one or more features of the set of features. The localized media generation platform adjusts the set of features in accordance with the user request. The localized media generation platform can transmit a set of notifications to the computing device responsive to receiving an indication of a user interaction with one or more of the set of localized media experiences. In some implementations, responsive to receiving an indication of a user interaction with the set of localized media experiences, the localized media generation platform links an indication of a digital collectible (e.g., digital collectibles 2104 in FIG. 21) to the user (e.g., the user 2106 in FIG. 21).

### Example Implementation of the Models of the Localized Media Generation Platform

FIG. 23 illustrates a layered architecture of an AI system 2300 that can implement the ML models of the localized media generation platform, in accordance with some implementations of the present technology. Example ML models can include the models executed by the localized media generation platform. Accordingly, the models of the localized media generation platform can include one or more components of the AI system 2300.

As shown, the AI system 2300 can include a set of layers, which conceptually organize elements within an example network topology for the AI system's architecture to implement a particular AI model. Generally, an AI model is a computer-executable program implemented by the AI system 2300 that analyzes data to make predictions. Information can pass through each layer of the AI system 2300 to generate outputs for the AI model. The layers can include a data layer 2302, a structure layer 2304, a model layer 2306, and an application layer 2308. The algorithm 2316 of the structure layer 2304 and the model structure 2320 and model parameters 2322 of the model layer 2306 together form an example AI model. The loss function engine 2324, optimizer 2326, and regularization engine 2328 work to refine and optimize the AI model, and the data layer 2302 provides resources and support for application of the AI model by the application layer 2308.

The data layer 2302 acts as the foundation of the AI system 2300 by preparing data for the AI model. As shown, the data layer 2302 can include two sub-layers: a hardware platform 2310 and one or more software libraries 2312. The hardware platform 2310 can be designed to perform operations for the AI model and include computing resources for storage, memory, logic, and networking, such as the resources described in relation to FIGS. 24 and 25. The hardware platform 2310 can process amounts of data using one or more servers. The servers can perform backend operations such as matrix calculations, parallel calculations, ML training, and the like. Examples of servers used by the hardware platform 2310 include central processing units (CPUs) and graphics processing units (GPUS). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 2310 can include computing resources, (e.g., servers, memory, etc.) offered by a cloud services provider. The hardware platform 2310 can also include computer memory for storing data about the AI model, application of the AI model, and training data for the AI model. The computer memory can be a form of random-access memory (RAM), such as dynamic RAM, static RAM, and non-volatile RAM.

The software libraries 2312 can be thought of as suites of data and programming code, including executables, used to control the computing resources of the hardware platform 2310. The programming code can include low-level primitives (e.g., fundamental language elements) that form the foundation of one or more low-level programming languages, such that servers of the hardware platform 2310 can use the low-level primitives to carry out specific operations. The low-level programming languages do not require much, if any, abstraction from a computing resource's instruction set architecture, enabling them to run quickly with a small memory footprint. Examples of software libraries 2312 that can be included in the AI system 2300 include INTEL Math Kernel Library, NVIDIA cuDNN, EIGEN, and OpenBLAS.

The structure layer 2304 can include an ML framework 2314 and an algorithm 2316. The ML framework 2314 can be thought of as an interface, library, or tool that enables users to build and deploy the AI model. The ML framework 2314 can include an open-source library, an API, a gradient-boosting library, an ensemble method, and/or a deep learning toolkit that works with the layers of the AI system to facilitate development of the AI model. For example, the ML framework 2314 can distribute processes for application or training of the AI model across multiple resources in the hardware platform 2310. The ML framework 2314 can also include a set of pre-built components that have the functionality to implement and train the AI model and enable users to use pre-built functions and classes to construct and train the AI model. Thus, the ML framework 2314 can be used to facilitate data engineering, development, hyperparameter tuning, testing, and training for the AI model. Examples of ML frameworks 2314 that can be used in the AI system 2300 include TENSORFLOW, PYTORCH, SCIKIT-LEARN, KERAS, LightGBM, RANDOM FOREST, and AMAZON WEB SERVICES.

The algorithm 2316 can be an organized set of computer-executable operations used to generate output data from a set of input data and can be described using pseudocode. The algorithm 2316 can include complex code that enables the computing resources to learn from new input data and create new/modified outputs based on what was learned. In some implementations, the algorithm 2316 can build the AI model through being trained while running computing resources of the hardware platform 2310. This training enables the algorithm 2316 to make predictions or decisions without being explicitly programmed to do so. Once trained, the algorithm 2316 can run at the computing resources as part of the AI model to make predictions or decisions, improve computing resource performance, or perform tasks. The algorithm 2316 can be trained using supervised learning, unsupervised learning, semi-supervised learning, and/or reinforcement learning.

Using supervised learning, the algorithm 2316 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected (e.g., in the form of user input 1802, 1904, 2004 in FIGS. 18, 19, and 20 respectively) from various source computing systems described in relation to FIGS. 1-22. Furthermore, training data can include pre-processed data generated by various engines of the localized media generation platform described in relation to FIGS. 1-22. The user may label the training data based on one or more classes and trains the AI model by inputting the training data into the algorithm 2316. The algorithm 2316 determines how to label the new data based on the labeled training data. The user can facilitate collection, labeling, and/or input via the ML framework 2314. In some instances, the user may convert the training data to a set of feature vectors for input to the algorithm 2316. Once trained, the user can test the algorithm 2316 on new data to determine whether the algorithm 2316 is predicting accurate labels for the new data. For example, the user can use cross-validation methods to test the accuracy of the algorithm 2316 and retrain the algorithm 2316 on new training data if the results of the cross-validation are below an accuracy threshold.

Supervised learning can include classification and/or regression. Classification techniques include teaching the algorithm 2316 to identify a category of new observations based on training data and are used when input data for the algorithm 2316 is discrete. Said differently, when learning through classification techniques, the algorithm 2316 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 2316 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques include estimating relationships between independent and dependent variables and are used when input data to the algorithm 2316 is continuous. Regression techniques can be used to train the algorithm 2316 to predict or forecast relationships between variables. To train the algorithm 2316 using regression techniques, a user can select a regression method for estimating the parameters of the model. The user collects and labels training data that is input to the algorithm 2316 such that the algorithm 2316 is trained to understand the relationship between data features and the dependent variable(s). Once trained, the algorithm 2316 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning-based pre-processing operations.

Under unsupervised learning, the algorithm 2316 learns patterns from unlabeled training data. In particular, the algorithm 2316 is trained to learn hidden patterns and insights of input data, which can be used for data exploration or for generating new data. Here, the algorithm 2316 does not have a predefined output, unlike the labels output when the algorithm 2316 is trained using supervised learning. Said another way, unsupervised learning is used to train the algorithm 2316 to find an underlying structure of a set of data, group the data according to similarities, and represent that set of data in a compressed format. The localized media generation platform can use unsupervised learning to identify patterns in claim history (e.g., to identify particular event sequences) and so forth. In some implementations, performance of the models of the localized media generation platform that can use unsupervised learning is improved because the incoming user input 1802, 1904, 2004 in FIGS. 18, 19, and 20 respectively are pre-processed and reduced, based on the relevant triggers, as described herein.

A few techniques can be used in supervised learning: clustering, anomaly detection, and techniques for learning latent variable models. Clustering techniques include grouping data into different clusters that include similar data, such that other clusters contain dissimilar data. For example, during clustering, data with possible similarities remain in a group that has fewer or no similarities to another group. Examples of clustering techniques include density-based methods, hierarchical-based methods, partitioning methods, and grid-based methods. In one example, the algorithm 2316 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 2316 may be trained to be an Isolation Forest, local outlier factor (LOF) algorithm, or k-nearest neighbor (k-NN) algorithm. Latent variable techniques include relating observable variables to a set of latent variables. These techniques assume that the observable variables are the result of an individual's position on the latent variables and that the observable variables have nothing in common after controlling for the latent variables. Examples of latent variable techniques that may be used by the algorithm 2316 include factor analysis, item response theory, latent profile analysis, and latent class analysis.

The model layer 2306 implements the AI model using data from the data layer 2302 and the algorithm 2316 and ML framework 2314 from the structure layer 2304, thus enabling decision-making capabilities of the AI system 2300. The model layer 2306 includes a model structure 2320, model parameters 2322, a loss function engine 2324, an optimizer 2326, and a regularization engine 2328.

The model structure 2320 describes the architecture of the AI model of the AI system 2300. The model structure 2320 defines the complexity of the pattern/relationship that the AI model expresses. Examples of structures that can be used as the model structure 2320 include decision trees, support vector machines, regression analyses, Bayesian networks, Gaussian processes, genetic algorithms, and artificial neural networks (or, simply, neural networks). The model structure 2320 can include a number of structure layers, a number of nodes (or neurons) at each structure layer, and activation functions of each node. Each node's activation function defines how the node converts data received to data output. The structure layers may include an input layer of nodes that receive input data and an output layer of nodes that produce output data. The model structure 2320 may include one or more hidden layers of nodes between the input and output layers. The model structure 2320 can be an artificial neural network (or, simply, neural network) that connects the nodes in the structured layers such that the nodes are interconnected. Examples of neural networks include feedforward neural networks, CNNs, recurrent neural networks (RNNs), autoencoder, and generative adversarial networks (GANs).

The model parameters 2322 represent the relationships learned during training and can be used to make predictions and decisions based on input data. The model parameters 2322 can weight and bias the nodes and connections of the model structure 2320. For instance, when the model structure 2320 is a neural network, the model parameters 2322 can weight and bias the nodes in each layer of the neural networks, such that the weights determine the strength of the nodes and the biases determine the thresholds for the activation functions of each node. The model parameters 2322, in conjunction with the activation functions of the nodes, determine how input data is transformed into desired outputs. The model parameters 2322 can be determined and/or altered during training of the algorithm 2316.

The loss function engine 2324 can determine a loss function, which is a metric used to evaluate the AI model's performance during training. For instance, the loss function engine 2324 can measure the difference between a predicted output of the AI model and the actual output of the AI model and is used to guide optimization of the AI model during training to minimize the loss function. The loss function may be presented via the ML framework 2314, such that a user can determine whether to retrain or otherwise alter the algorithm 2316 if the loss function is over a threshold. In some instances, the algorithm 2316 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 2326 adjusts the model parameters 2322 to minimize the loss function during training of the algorithm 2316. In other words, the optimizer 2326 uses the loss function generated by the loss function engine 2324 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF), and Limited-memory BFGS (L-BFGS). The type of optimizer 2326 used may be determined based on the type of model structure 2320 and the size of data and the computing resources available in the data layer 2302.

The regularization engine 2328 executes regularization operations. Regularization is a technique that prevents over-and underfitting of the AI model. Overfitting occurs when the algorithm 2316 is overly complex and too adapted to the training data, which can result in poor performance of the AI model. Underfitting occurs when the algorithm 2316 is unable to recognize even basic patterns from the training data such that it cannot perform well on training data or on validation data. The optimizer 2326 can apply one or more regularization techniques to fit the algorithm 2316 to the training data properly, which helps constrain the resulting AI model and improves its ability for generalized application. Examples of regularization techniques include lasso (L1) regularization, ridge (L2) regularization, and elastic (L1 and L2) regularization.

The application layer 2308 describes how the AI system 2300 is used to solve problems or perform tasks. In an example implementation, the application layer 2308 can include a front-end user interface of the localized media generation platform.

### Example Computing Environment of the Localized Media Generation Platform

FIG. 24 is a block diagram showing some of the components typically incorporated in at least some of the computer systems 2400 and other devices on which the disclosed system operates in accordance with some implementations of the present technology. As shown, an example computer system 2400 can include: one or more processors 2402, main memory 2408, non-volatile memory 2412, a network interface device 2414, a video display device 2420, an input/output device 2422, a control device 2424 (e.g., keyboard and pointing device), a drive unit 2426 that includes a machine-readable medium 2428, and a signal generation device 2432 that are communicatively connected to a bus 2418. The bus 2418 represents one or more physical buses and/or point-to-point connections that are connected by appropriate bridges, adapters, or controllers. Various common components (e.g., cache memory) are omitted from FIG. 24 for brevity. Instead, the computer system 2400 is intended to illustrate a hardware device on which components illustrated or described relative to the examples of the figures and any other components described in this specification can be implemented.

The computer system 2400 can take any suitable physical form. For example, the computer system 2400 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 2400. In some implementations, the computer system 2400 can be an embedded computer system, a system-on-chip (SOC), a single-board computer system (SBC) or a distributed system such as a mesh of computer systems or can include one or more cloud components in one or more networks. Where appropriate, one or more computer systems 2400 can perform operations in real time, in near real time, or in batch mode.

The network interface device 2414 enables the computer system 2400 to exchange data in a network 2416 with an entity that is external to the computer system 2400 through any communication protocol supported by the computer system 2400 and the external entity. Examples of the network interface device 2414 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 2408, non-volatile memory 2412, machine-readable medium 2428) can be local, remote, or distributed. Although shown as a single medium, the machine-readable medium 2428 can include multiple media (e.g., a centralized/distributed database and/or associated caches and servers) that store one or more sets of instructions 2430. The machine-readable (storage) medium 2428 can include any medium that is capable of storing, encoding, or carrying a set of instructions for execution by the computer system 2400. The machine-readable medium 2428 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 2410, 2430) set at various times in various memory and storage devices in computing device(s). When read and executed by the processor 2402, the instruction(s) cause the computer system 2400 to perform operations to execute elements involving the various aspects of the disclosure.

FIG. 25 is a system diagram illustrating an example of a computing environment 2500 in which the disclosed system operates in some implementations. In some implementations, the computing environment 2500 includes one or more client computing devices 2505A-D, examples of which can host the localized media generation platform. Client computing devices 2505 operate in a networked environment using logical connections through network 2530 to one or more remote computers, such as a server computing device.

In some implementations, server 2510 (e.g., server computing device) is an edge server that receives client requests and coordinates fulfillment of those requests through other servers, such as servers 2520A-C. In some implementations, server computing devices 2510 and 2520 comprise computing systems, such as the localized media generation platform. Though each server computing device 2510 and 2520 is displayed logically as a single server, each server computing device can be a distributed computing environment encompassing multiple computing devices located at the same or at geographically disparate physical locations. In some implementations, each server 2520 corresponds to a group of servers.

Client computing devices 2505 and server computing devices 2510 and 2520 can each act as a server or client to other server or client devices. In some implementations, servers (2510, 2520A-C) connect to a corresponding database (2515, 2525A-C). As discussed above, each server 2520 can correspond to a group of servers, and each of these servers can share a database or can have its own database. Databases 2515 and 2525 warehouse (e.g., store) information such as claims data, email data, call transcripts, call logs, policy data, and so on. Though databases 2515 and 2525 are displayed logically as single units, databases 2515 and 2525 can each be a distributed computing environment encompassing multiple computing devices, can be located within their corresponding server, or can be located at the same or at geographically disparate physical locations.

Network 2530 can be a local area network (LAN) or a wide area network (WAN), but can also be other wired or wireless networks. In some implementations, network 2530 is the Internet or some other public or private network. Client computing devices 2505 are connected to network 2530 through a network interface, such as by wired or wireless communication. While the connections between server 2510 and servers 2520 are shown as separate connections, these connections can be any kind of local, wide area, wired, or wireless network, including network 2530 or a separate public or private network.

### Conclusion

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples; alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include additional elements to those implementations noted above or can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification unless the above Detailed Description section explicitly defines such terms. Accordingly, the actual scope of the technology encompasses not only the disclosed examples but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right after filing this application to pursue such additional claim forms, either in this application or in a continuing application.

From the foregoing, it will be appreciated that specific implementations of the invention have been described herein for purposes of illustration but that various modifications can be made without deviating from the scope of the invention. Accordingly, the invention is not limited except as by the appended claims.

1. A computer-implemented method for dynamic generation of sequenced location-based media using artificial intelligence, the method comprising:
receiving, at a computing device associated with a user, a user input to initiate presentation of location-based media at a first geographic zone of a plurality of geographic zones that each include computer-readable data representing a corresponding physical geographic area;
determining, by the computing device, a set of features associated with the user, wherein the set of features defines one or more of: a set of user preferences or a set of historical interaction patterns;
dynamically generating, using a first set of artificial intelligence (AI) models, a first set of location-based media associated with the first geographic zone by:
mapping the set of features associated with the user to a latent space to generate a set of feature vectors representative of the set of features,
inputting the set of feature vectors into one or more input nodes of the first set of AI models, and
receiving, from one or more output nodes of the first set of AI models, the first set of location-based media, each of which is a media experience,
wherein each location-based media of the first set of location-based media comprises interactive content configured for user engagement within the first geographic zone, and
wherein a distance between a vector representation of each location-based media within the first set of location-based media and the set of feature vectors satisfies a predetermined threshold;
mapping the first set of location-based media to a first unique identifier of a first marker that is configured with a first processing circuitry and uniquely associated with the first geographic zone,
wherein each location-based media in the first set of location-based media is accessible by the computing device based on a first proximity between the computing device and the first marker;
presenting a display representing the first set of location-based media on the computing device;
responsive to determining that the user has relocated to a second geographic zone of the plurality of geographic zones, applying a second set of AI models to an input that includes one or more of: the first set of location-based media, a direction of movement of the user, or a pattern of movement of the user;
generate, as an output of the second set of AI models, a second set of location-based media associated with the second geographic zone,
wherein each location-based media of the second set of location-based media comprises interactive content configured for user engagement within the second geographic zone; and
mapping the second set of location-based media to a second unique identifier of a second marker that is configured with a second processing circuitry and uniquely associated with the second geographic zone,
wherein each location-based media in the second set of location-based media is accessible by the computing device based on a second proximity between the computing device and the second marker; and
updating the display to represent the second set of location-based media on the computing device.

2. The method of claim 1,
wherein the distance is a first distance,
wherein the second set of location-based media is generated by inputting the set of feature vectors into one or more input nodes of the second set of AI models to output, from one or more output nodes of the second set of AI models, the second set of location-based media, and
wherein a second distance between a vector representation of each location-based media within the second set of location-based media and the set of feature vectors satisfies the predetermined threshold.

3. The method of claim 1, further comprising:
causing presentation of the first set of location-based media through the computing device; and
causing presentation of the second set of location-based media through the computing device.

4. The method of claim 1, further comprising:
determining, by the computing device, a set of pre-loaded query context associated with the user,
wherein the set of pre-loaded query context defines a collection of predefined prompts used by the first set of AI models to generate the first set of location-based media and the second set of location-based media based on one or more of: a user category or a set of historical user queries.

5. The method of claim 1, wherein the first set of AI models and the second set of AI models comprise one or more encoder-decoder architectures that project the set of feature vectors into a shared latent space and reconstruct the set of feature vectors into media representations.

6. The method of claim 1, wherein the first set of location-based media and the second set of location-based media comprise one or more of: music, sounds, text, pictures, or video data.

7. The method of claim 1, wherein one or more location-based media in the first set of location-based media are accessed by the computing device using a webhook.

8. At least one computer-readable storage medium, excluding transitory signals and carrying instructions, which, when executed by at least one data processor of a system, cause the system to:
receive, at a computing device associated with a user, a user input to initiate a localized media experience at a plurality of geographic zones that each include computer-readable data representing a corresponding physical geographic area;
determine, by the computing device, a set of features associated with the user, wherein the set of features defines one or more of: a set of user preferences or a set of historical interaction patterns;
dynamically generate, using a set of artificial intelligence (AI) models, a set of interactive localized media experiences associated with the plurality of geographic zones by, for each geographic zone:
mapping the set of features associated with the user to a latent space to generate a set of feature vectors representative of the set of features,
inputting the set of feature vectors into one or more input nodes of the set of AI models, and
receiving, from one or more output nodes of the set of AI models, one or more interactive localized media experiences of the set of interactive localized media experiences,
wherein each interactive localized media experience of the set of interactive localized media experiences comprises interactive content configured for user engagement within a respective geographic zone;
dynamically generate, using the set of interactive localized media experiences associated with the plurality of geographic zones, a set of experience combinations defining an ordered or partially ordered set of interactive localized media experiences selected from different geographic zones within the plurality of geographic zones;
responsive to determining that the user is located at a particular geographic zone of the plurality of geographic zones, select (1) a particular interactive localized media experience within the set of interactive localized media experiences and (2) a particular experience combination based on the particular interactive localized media experience,
wherein the particular interactive localized media experience is selected based on one or more of: a proximity between the computing device and a corresponding beacon of the particular interactive localized media experience, a direction of movement of the user, or historical interactive localized media experiences previously presented on the computing device; and
cause presentation of the particular interactive localized media experience on the computing device.

9. The at least one computer-readable storage medium of claim 8, wherein causing presentation of the particular interactive localized media experience is based on a set of criteria, wherein the set of criteria is associated with one or more of:
a predetermined time period,
a length of an audio segment,
a first duration of time the user is located within the particular geographic zone, or
a second duration of time since a presentation of a previous interactive localized media experience.

10. The at least one computer-readable storage medium of claim 8, wherein the system is further caused to:
obtain a set of user variability parameters defining a set of user groups;
assign the user to a specific user group within the set of user groups based on a degree of satisfaction of the set of features of the user with one or more user variability parameters of the set of user variability parameters; and
select one or more of: (1) the particular interactive localized media experience or (2) the particular experience combination based on the specific user group assigned to the user.

11. The at least one computer-readable storage medium of claim 8,
cause communication with one or more external application programming interfaces associated with the particular geographic zone to retrieve additional contextual data,
wherein the particular interactive localized media experience is selected based on the additional contextual data.

12. The at least one computer-readable storage medium of claim 8, wherein generating the set of interactive localized media experiences is based on one or more of:
a previous location of the user,
a previous localized media experience presented to the user,
a set of operating hours associated with the plurality of geographic zones,
a proximity to an additional computing device, or
a degree of Internet connectivity of the computing device.

13. The at least one computer-readable storage medium of claim 8, wherein the system is further caused to:
modify the set of features of the user based on a set of user interactions with the set of interactive localized media experiences.

14. The at least one computer-readable storage medium of claim 8, wherein the set of interactive localized media experiences includes one or more of:
an interactive tour,
a game, or
an interactive storytelling experience.

15. A system comprising:
at least one hardware processor; and
at least one non-transitory memory storing instructions, which, when executed by the at least one hardware processor, cause the system to:
receive, at a computing device associated with a user, a user input to initiate a localized media experience at a plurality of geographic zones that each include computer-readable data representing a corresponding geographic area;
determine, by the computing device, a set of features associated with the user,
wherein the set of features defines one or more of: a set of user preferences or a set of historical interaction patterns;
dynamically generate, using a first set of artificial intelligence (AI) models, a set of command sets, each of which is configured to cause a second set of AI models to generate a corresponding set of localized media experiences associated with one or more of geographic zones by:
mapping the set of features associated with the user to a latent space to generate a set of feature vectors representative of the set of features,
inputting the set of feature vectors into one or more input nodes of the first set of AI models, and
receiving, from one or more output nodes of the first set of AI models, one or more command sets of the set of command sets;
responsive to determining that the user is located at a particular geographic zone of the plurality of geographic zones, select a particular command set within the set of command sets based on one or more of: the particular geographic zone of the user, a direction of movement of the user, or historical command sets previously input into the second set of AI models;
input, as an input into the second set of AI models, the particular command set,
wherein the corresponding set of localized media experiences are associated with a unique identifier of a beacon that is configured with a processing circuitry and uniquely associated with the particular geographic zone;
generate, as an output of the second set of AI models, a set of localized media experiences,
wherein each localized media experience of the set of localized media experiences comprises interactive content configured for user engagement within the particular geographic zone; and
cause presentation of the set of localized media experiences on the computing device.

16. The system of claim 15, wherein the corresponding geographic area represents one or more virtual positions.

17. The system of claim 15, wherein the system is further caused to:
receive a user request to add, modify, or remove one or more features of the set of features; and
adjust the set of features in accordance with the user request.

18. The system of claim 15, wherein selecting the particular command set is further based on one or more of:
a direction of approach to the particular geographic zone,
a time of day,
a day of a week,
an age of the user,
a date,
a weather temperature, or
a weather type.

19. The system of claim 15, wherein the system is further caused to:
transmit a set of notifications to the computing device responsive to receiving an indication of a user interaction with one or more of the set of localized media experiences.

20. The system of claim 15, wherein the system is further caused to:
responsive to receiving an indication of a user interaction with the set of localized media experiences, linking an indication of a digital collectible to the user; and
cause display of the indication of the digital collectible on the computing device.
